(19) United States
(12) Patent Application Publication
(10) Pub. No.: US 2006/0262737 A1
(43) Pub. Date: Nov. 23, 2006

(54) QoS management in wireless mesh networks

(75) Inventors: Catherine Livet, Montreal (CA); Vincent Roy, Montreal (CA); Juan Carlos Zuniga, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/369,297

(22) Filed: Mar. 7, 2006

Related U.S. Application Data
(60) Provisional application No. 60/660,828, filed on Mar. 11, 2005.

(51) Int. Cl. H04L 12/28; H04L 12/56

(52) U.S. Cl. 370/254; 370/406

(57) ABSTRACT

A mesh network includes a plurality of mesh points (MPs), a central database (DB) and a central controller (CC). The MPs are configured to broadcast quality of service (QoS) information over a wireless medium. Each MP may request QoS information directly from at least one other one of the MPs. The MPs store QoS information in the central DB and are configured to query the central DB QoS information associated with any of the MPs. Thus, QoS information is shared throughout the mesh network, and QoS policies are defined and updated where an MP may co-exist with another MP, an MP may co-exist with systems external to the mesh network, and an MP may co-exist with mesh access points (MAPs).

### CROSS REFERENCE TO RELATED APPLICATION

This application claims the benefit of U.S. Provisional Application No. 60/660,828 filed Mar. 11, 2005, which is incorporated by reference as if fully set forth.

### FIELD OF INVENTION

The present invention is related to a wireless communication system. More particularly, the present invention is related to a medium access control (MAC) layer quality of service (QoS) enhancement for a mesh application that allows QoS information to be shared, and QoS policies to be defined.

### BACKGROUND

Wireless local area network (WLAN) systems were originally designed to offer best effort services to ensure fairness amongst all users in accessing the wireless medium. This meant that little consideration was put on providing the means by which QoS could be guaranteed to users or by which the differences between QoS requirements of each user could be considered. As the desire for using WLAN systems to support QoS-driven applications such as voice over Internet protocol (VOIP) and real-time video applications grew, standardization bodies such as IEEE 802.11e were formed to address the issue.

Additionally, WLAN networks are evolving to introduce a wireless backhaul connection between access points (APs) in a mesh fashion. The interest of this mesh architecture is to provide low cost, ease of use and quick deployment. It is expected that mesh networks will face the same QoS requirements as other WLAN systems.

### SUMMARY

The present invention is a mesh network which includes a plurality of mesh points (MPs), a central database (DB) and a central controller (CC). The MPs are configured to broadcast QoS information over a wireless medium. Each MP may request QoS information directly from at least one of the other MPs. The MPs store QoS information in the central DB and are configured to query the central DB QoS information associated with any of the MPs. Thus, QoS information is shared throughout the mesh network and QoS policies are defined and updated. An MP may co-exist with another MP, an MP may co-exist with systems external to the mesh network, and an MP may co-exist with mesh access points (MAPs).

### BRIEF DESCRIPTION OF THE DRAWINGS

A more detailed understanding of the invention may be had from the following description of a preferred example, given by way of example and to be understood in conjunction with the accompanying drawings wherein:

FIG. 1 illustrates different implementations of QOS information exchange using signaling in a mesh network including a plurality of MPs, a central DB and a CC in accordance with one embodiment of the present invention;

FIG. 2 illustrates different implementations of signaling for mesh QoS adaptation and update operation in accordance with another embodiment of the present invention;

FIG. 3 illustrates multiple mesh QoS policies adaptation in accordance with another embodiment of the present invention;

FIG. 4 illustrates a scenario where a mesh network can be deployed in a location where an IEEE 802.11e network already exists in accordance with another embodiment of the present invention; and

FIG. 5 illustrates adaptation of mesh QoS policies to external IEEE 802.11e QoS policy information in accordance with another embodiment of the present invention.

### DETAILED DESCRIPTION OF THE PREFERRED EMBODIMENTS

The preferred embodiments will be described with reference to the drawing figures where like numerals represent like elements throughout.

Hereafter, the terminology “client STA” includes but is not limited to a wireless transmit/receive unit (WTRU), a user equipment (UE), a mobile station, a fixed or mobile subscriber unit, a pager, or any other type of device capable of operating in a wireless environment.

When referred to hereafter, an AP includes but is not limited to a Node-B, a base station, a site controller or any other type of interfacing device in a wireless environment.

When referred to hereafter, the terminology “backhaul” refers to the wireless interface between mesh points (MPs) whereas the terminology “client access” refers to the interface between an AP and a client STA, which is also known as Basic Service Set (BSS). Although references will be made to IEEE 802.11e and IEEE 802.11 standard groups and documents, the present invention may be applicable to any mesh architecture supporting QoS policies.

The features of the present invention may be incorporated into an integrated circuit (IC) or be configured in a circuit comprising a multitude of interconnecting components.

IEEE 802.11e standardized a priority-based QoS mechanism called enhanced distributed channel access (EDCA). It stipulates the required mechanisms and signaling by which an AP and its associated client STA can exchange information about the user's application requirements and the AP's ability to allocate the required radio resources to the STA.

In mesh networks, where the wireless medium can be shared between a multiplicity of MPs, APs and STAs, the current state-of-the-art can lead to two important problems:

1) Lack of coherence between QoS policies used in backhaul wireless interface. The relation between a standard AP and its STA could be seen as one of master and slave, as the AP orders the associated STAs to use given priority policies. By definition, a mesh network is likely to have multiple MPs sharing the same wireless medium. In such systems, the relation between MPs is closer to one of equals. This opens up the possibility of different MPs using different priority policies and thus competing for radio resources in a destructive manner.

2) Lack of coherence between QoS policies used in backhaul and the client access wireless interfaces. The mesh backhaul, (where MPs talk to MPs), and the client access wireless interfaces, (where a client STA communicates with an AP), can co-exist in the same system. The fact that both backhaul and client access can operate on the same channel opens up the possibility of both layers competing for the radio resources in a destructive manner instead of in a constructive one.

In one embodiment, signaling is implemented which allows QoS information to be exchanged in a mesh network. The QoS information that is shared using this method could include, but is not limited to:

1) The QoS Configuration Parameters used by the MP. For example, in a CSMA scheme, this could correspond to the different EDCA parameter sets, or sets of channel access parameters that the MP uses for each QoS class when contending for the shared medium. Similar to the IEEE 802.11e Access Categories (AC), ACs can be defined for a mesh network, (e.g., Mesh_AC1, Mesh_AC2, Mesh_AC3, Mesh_AC4), and it can be assumed that same type of mapping is used to map between the IEEE 802.1d priority tag, (user priority (UP)), and the mesh AC. The parameters defining the EDCA QoS Policy, such as the minimum idle delay before contention, (arbitration interframe space number (AIFSN)), and the minimum and maximum contention windows (CWs), (CWmin and CWmax), and transmission opportunity (TXOP) limit parameters can be different for each AC within an MP. The information may also include, but it is not limited to, acknowledgement policy supported in the mesh network and pre-determined rules that would allow two or more different MPs to synchronize their QoS policies.

Examples of such predetermined rules would be: i) upon association of two MPs, the MPs will use the EDCA parameter set of the MPs that has the most discriminatory QoS policies, (i.e., the one with the greatest differences in ECDA parameter set between QoS ACs); ii) upon association of two MPs, the MPs will use the EDCA parameter set of the MP that has been active the longest; iii) upon association of two MPs, the MPs will use the EDCA parameter set of the MP closest to a portal; and iv) upon association of two MPs, the MPs will use the EDCA parameter set of the MP that supports the most traffic, or the like.

2) Information related to resources allocated by an MP. Examples of measures that can be used to express allocated resources include, but are not limited to, allocated time units, number of packets, number of bytes, number of traffic streams, channel utilization, AC buffer occupancy, or the like. All this information can be provided per AC.

3) Information related to resources used by an MP. Examples of measures that can be used to express used resources include, but are not limited to, transmission times, channel occupancy, number of packets transmitted, number of bytes transmitted, number of traffic streams, channel utilization, AC buffer occupancy, or the like. All this information can be provided per AC.

4) The quality experienced by a MP for each of its forwarding, (i.e., backhaul), links. Examples of measures that can be used to express the quality experienced by MPs include, but are not limited to, time jitter, time latency, packet error rate, throughput, queued time, or the like.

5) The QoS policies, (e.g., EDCA parameters set), used in coexisting IEEE 802.11e client access wireless interfaces that are external to the mesh network.

6) The QoS policies, (e.g. EDCA parameters set), used on the IEEE 802.11e client access wireless interface of mesh APs.

The signaling can be implemented by, but is not limited to:

1) Having the MPs broadcast this information over the wireless medium using management frames or control frames or higher layer messages transported as the payload of data frames.

2) Having MPs request QoS information directly from each other. This can be achieved using management frames or control frames or using higher layer messages transported as payload of data frames.

3) Having each MP store its QoS information in a central DB located on a server and be able to query the QoS information associated to any MP from that central DB.

4) Having the MPs report this information to a Central Controller (CC) and having the CC relay this information to the MPs. The determination of which MPs will the CC send the information includes, but is not limited to, the MPs requesting the information to the CC; the CC sending the information to all MPs; and the CC sending the information relative to the MPs of a given area only to the MPs sharing the wireless medium within that area. This can be achieved by having the MP reporting to the CC that the MP can hear, (above its deferring threshold).

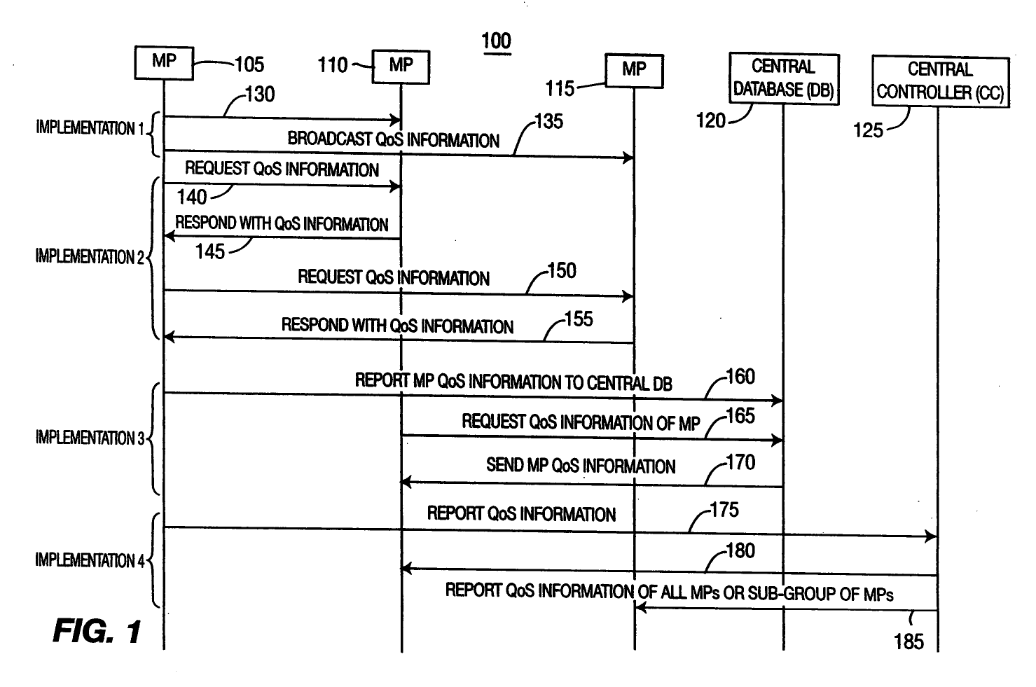

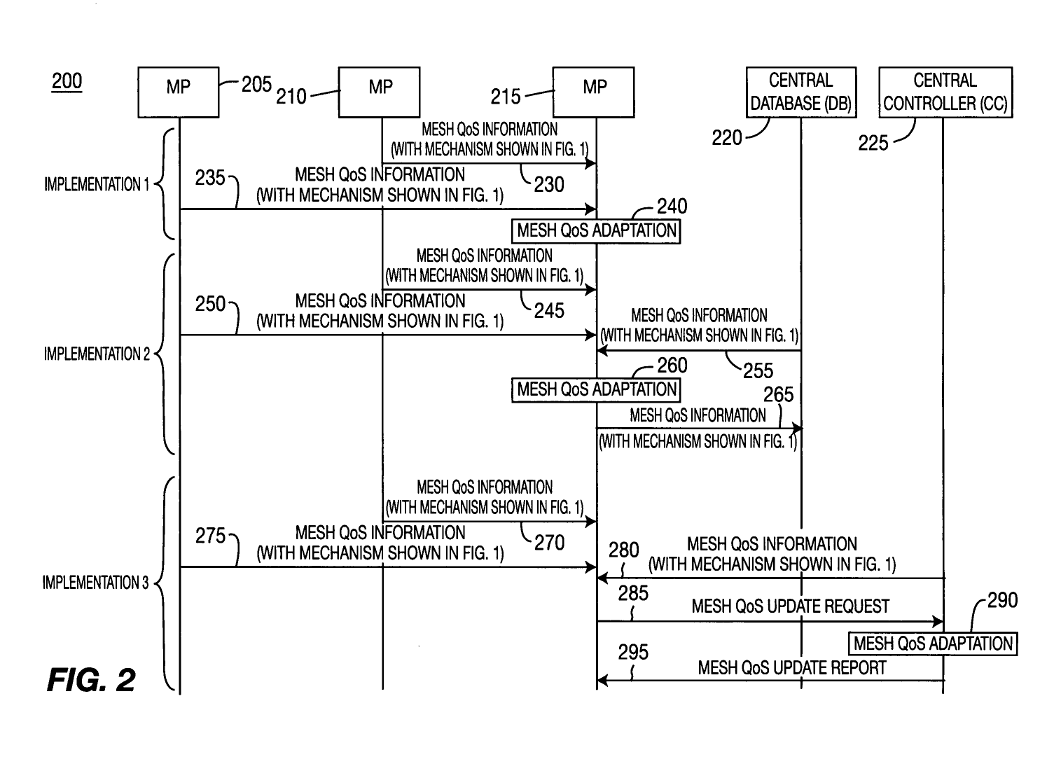

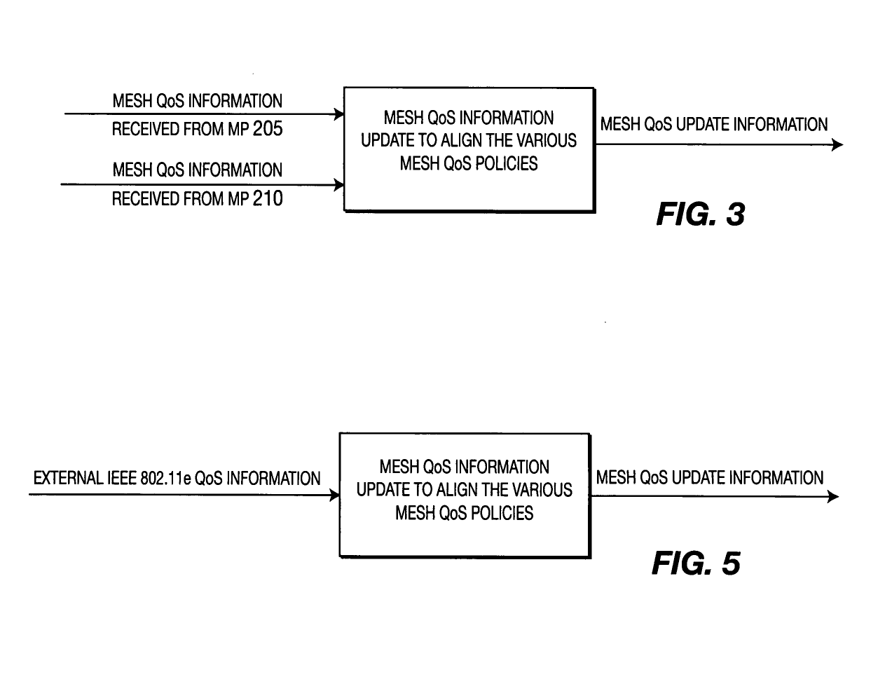

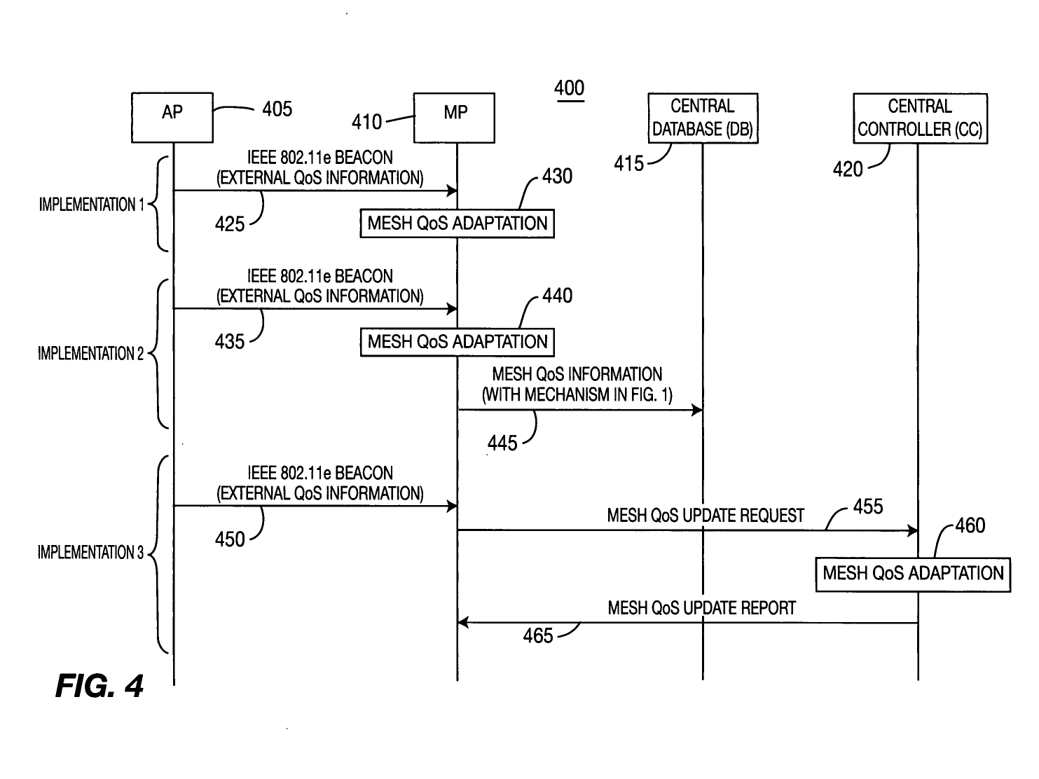

FIG. 1 illustrates these different implementations of signaling in a mesh network 100 including a plurality of mesh points (MPs), 105, 110, 115, a central DB 120 and a CC 125 in accordance with the present invention. FIG. 1 illustrates how QOS information is shared and exchanged between the MPs 105, 110, 115. This can be done by the MPs 105, 110, 115 sending each other packets or it can be done through the central DB 120 or the CC 125.

In a first implementation, one of the MPs, MP 105, broadcasts its QoS information to the other MPs 110, 115 (steps 130, 135), each of which, in turn, stores the QoS information in a memory (not shown).

In a second implementation, one of the MPs, MP 105, requests QoS information from the other MPs 110, 115 (steps 140, 150) which, in turn, each respond with their QoS information (steps 145, 155).

In a third implementation, at least one of the MPs, (e.g., MP 105), reports its QoS information to the central DB 120 (step 160) which stores the MP QoS information in a memory (not shown). When an MP, MP 110, requests QoS information about another MP, MP 105, the central DB 120 sends QoS information of MP 105 to MP 110 (step 170).

In a fourth implementation, at least one of the MPs, (e.g., MP 105), reports MP QoS information 175 associated with the MP to the CC 125 (step 175) which, in turn, reports the MP QoS information to either all or a subset of the MPs 105, 110, 115 as a broadcast or in response to a request from one of the MPs 105, 110, 115 (steps 180, 185).

In one embodiment, QoS policies are defined and updated in a mesh network where an MP only co-exists with other MPs. An MP can receive QoS information from various MPs that can be from the same Mesh network or from different Mesh networks. The present invention allows the MP to update its own mesh QoS Policy and QoS information based on the received mesh QoS information.

FIG. 2 illustrates this embodiment in a mesh network 200 including a plurality of MPs, MP 205, MP 210, an MP 215, a central DB 220 and a CC 225 in accordance with one embodiment of the present invention.

In a first implementation, mesh QoS information 230, 235 is sent from each of the MPs 205, 210 to the MP 215 using one of the signaling exchanges illustrated in FIG. 1, (i.e., implementation 1 or 2 of FIG. 1), and the MP 215 updates, (i.e., adapts), its own mesh QoS Policy and QoS information based on the received mesh QoS information (step 240).

In a second implementation, the MP 215 learns about the QoS information 245, 250, 255 from the MP 205, the MP 210 and the central DB 220 using the signaling illustrated in FIG. 1, (i.e., implementation 1, 2 or 3 of FIG. 1), and updates, (i.e., adapts), its own mesh QoS Policy and QoS information based on the received mesh QoS information (step 260). The MP 215 then reports the new QoS Information to the central DB 220 (step 265).

In a third implementation, an MP 215 learns about the QoS information 270, 275, 280 from the MP 205, the MP 210 and the CC 225 using the signaling illustrated in FIG. 1, (i.e., implementation 1,2 or 4 of FIG. 1), and transmits a mesh QoS update request 285 to the CC 225. It should be noted that the MP 215 can append QoS information conveyed by the MP 205 and the MP 210 to the mesh QoS update request 285. The CC 225 updates QoS policy and QoS information (step 290), and then responds to the MP 215 with a mesh QoS update report 295 which indicates to the MP 215 which QoS information and QoS policy it should use. The mesh QoS adaptations 240, 260, 290 design the operations which analyze the various mesh QoS information and determines the one that is to be followed by the MP 215.

The mesh QoS adaptation can be performed in a distributed manner, (as shown in implementation 1 and implementation 2 of FIG. 2), which doesn't require additional signaling. The mesh QoS adaptation can also be done in a centralized way, (through the CC 225 in implementation 3 of FIG. 2).

The mesh QoS adaptation operation, as illustrated in FIG. 3, can be performed in several ways. For instance, it can consider each AC specific parameters of all the Mesh QoS Information received from the mesh networks 205, 210, (i.e., the parameters defining EDCA operation, such as the minimum idle delay before contention (AIFSN), the minimum and maximum contention windows (CWmin and CWmax), and TXOP limit parameters), rank the various AC priorities and then select the parameters the most suitable for addressing a certain required MP QoS.

FIG. 4 illustrates a scenario where a mesh network can be deployed in a location where an IEEE 802.11e network 400 already exists in accordance with another embodiment of the present invention. The IEEE 802.11e network 400 includes an IEEE 802.11e AP 405, an MP 410, a central DB 415 and a CC 420. The MP 410 co-exists with IEEE 802.11e networks external to the mesh network. This co-existence leads to a QoS competition between both networks if no coordination is made. It is assumed that a frequency selection algorithm will first be run to avoid, (as much as possible), the mesh network and the IEEE 802.11e network 400 operating in the same channel. However, situations can occur when all of the networks have to share the same radio and same channel.

In the IEEE 802.11e network 400, the MP 410 receives IEEE 802.11e beacons from the AP 405 (steps 425, 435, 450). The MP can then extract the IEEE 802.11e QoS information transmitted on the beacon and either perform a local mesh QoS adaptation (step 430 and 440). In a mesh network where QoS information is exchanged and shared using a centralized DB, MP 410 would update the centralized DB with the new QoS information (step 445). In a network where QoS adaptation is performed in a centralized fashion, MP 410 send a mesh QoS update request 455 to the CC 420 while appending the 802.11e QoS information in the message 445. The CC 420 then performs the QoS adaptation (step 460) and sends a mesh QoS update report 465 to the MP 410. The mesh QoS adaptation is required to take the external IEEE 802.11e QoS information into account within the mesh, as illustrated in FIG. 5.

A rule can be applied to align the mesh-related QoS information to the IEEE 802.11e QoS policy, or at least minimize a possible QoS conflict. The reverse, (i.e., align the IEEE 802.11e QoS to the mesh QoS), is not possible since the IEEE 802.11e AP cannot monitor the MP channel.

Examples of QoS adjustment rules that an MP can follow, but is not restricted to, include using the most discriminatory QoS policies between the mesh network and the IEEE 802.11e QoS Information, (e.g. EDCA Parameter Set), (i.e., the one with the greatest differences in ECDA parameter set between QoS ACs), defining mesh EDCA parameters with either better or worse priority for a same AC to favor either the mesh or the IEEE 802.11e network, or the like.

Whenever the MP has taken its decision and has modified the mesh EDCA parameter set, it has to propagate it to the rest of the mesh by the signaling allowing QoS information to be exchanged in a mesh network as described above.

In another embodiment, an MP co-exists with IEEE 802.11e MAPs. As previously described, MPs connect to both mesh backhaul and client access interfaces. MAPs may have one or multiple physical radios. For multi-radio devices, a frequency separation of both interfaces could be made by simply assigning different channels to them. However, for the single radio case and even sometimes for multiple radios, both interfaces could use the same radio channel. In this case, some co-ordination of QoS policies is required between both interfaces in order to have a coherent system over the same radio channel.

For having a coherent system that can support different QoS policies on both backhaul and client access interfaces, the mesh backhaul requires setup of both sets of parameters, either by making an a priori configuration, (e.g., default configuration), or by propagating the information between the different nodes when setting up the system or dynamically through system operation. Regarding the way the information is exchanged and distributed, a signaling scheme which allows QoS information to be exhanged in a mesh network may be used.

The present invention provides a method to coherently define and coordinate QoS policies between backhaul and client access interfaces of MAPs.

In its simplest form, the same parameters could be used for both interfaces, making traffic access equivalent for similar packets. This scenario can be illustrated as follows:

ACs priority mapping is shown in Table 1:

TABLE 1

| | Mesh backhaul | |
|---|---|---|
| Priority | ACs | Client Access ACs |
| 1 | Mesh_AC1 | AC1 |
| 2 | Mesh_AC2 | AC2 |
| 3 | Mesh_AC3 | AC3 |
| 4 | Mesh_AC4 | AC4 |

Hence, when setting up the system, or dynamically during system operation, the client access interface would need to replicate the same parameters on its side, for instance by advertising them on the beacon.

In a more sophisticated form, some traffic differentiation between backhaul and access side may be performed. For instance, ACs may be differentiated when traffic is traversing the mesh and when it is only accessing the client access side.

In order to achieve this, many approaches can be taken. One approach is to have different EDCA parameter sets, or sets of channel access parameters, for backhaul and client access so that packets traversing the mesh network could be differentiated from packets from the same AC just accessing the access channel. One possibility to achieve this traffic differentiation could be to map some of the already existing four ACs to the backhaul, and some to the client access traffic. Similarly, since ACs have originally been defined by IEEE-802.11e for client access traffic, another possibility could be to define more ACs, (i.e., on top of the four existing IEEE-802.11e ACs), in order to specifically handle the backhaul traffic. Another approach is to provide different TXOP parameters for traffic inside and outside of the mesh. Another approach is to provide different minimum and maximum contention windows, (CWmin and CWmax), for traffic inside and outside of the mesh. Another approach is to provide different inter-frame spacing (IFS) parameters for traffic inside and outside of the mesh.

For example, having different ACs for backhaul and client access could allow us to follow different traffic differentiation strategies, such as:

Interleaving of ACs priority are shown in Table 2:

TABLE 2

| | Mesh backhaul | |
|---|---|---|
| Priority | ACs | Client Access ACs |
| 1 | Mesh_AC1 | |
| 2 | | AC1 |
| 3 | Mesh_AC2 | |
| 4 | | AC2 |
| 5 | Mesh_AC3 | |
| 6 | | AC3 |
| 7 | Mesh_AC4 | |
| 8 | | AC4 |

Enfolding Client Access ACs with Mesh ACs as shown in Table 3:

TABLE 3

| Priority | Mesh backhaul ACs | Client Access ACs |
|---|---|---|
| 1 | Mesh_AC1 | |
| 2 | Mesh_AC2 | |
| 3 | | AC1 |
| 4 | | AC2 |
| 5 | | AC3 |
| 6 | | AC4 |
| 7 | Mesh_AC3 | |
| 8 | Mesh_AC4 | |

Pre-empting Client Access ACs with Mesh ACs as shown in Table 4:

TABLE 4

| Priority | Mesh backhaul ACs | Client Access ACs |
|---|---|---|
| 1 | Mesh_AC1 | |
| 2 | Mesh_AC2 | |
| 3 | Mesh_AC3 | |
| 4 | Mesh_AC4 | |
| 5 | | AC1 |
| 6 | | AC2 |
| 7 | | AC3 |
| 8 | | AC4 |

Pre-empting Mesh ACs with Client Access ACs as shown in Table 5:

TABLE 5

| Priority | Mesh backhaul ACs | Client Access ACs |
|---|---|---|
| 1 | | AC1 |
| 2 | | AC2 |
| 3 | | AC3 |
| 4 | | AC4 |
| 5 | Mesh_AC1 | |
| 6 | Mesh_AC2 | |
| 7 | Mesh_AC3 | |
| 8 | Mesh_AC4 | |

Other combinations are possible.

It is worth noting that these examples are based on the assumption that four (4) ACs are implemented on the backhaul side. The selection of four (4) ACs was an example and any other number of ACs is also possible. For instance, eight (8) ACs could be implemented on the mesh side, which could allow differentiating traffic even more, such as having the same category traffic differentiated depending on the number of hops through the network, depending on the technical specification, or the like. Also, a single AC could be use to bundle all traffic types that are traversing the backhaul.

Although the features and elements of the present invention are described in the preferred embodiments in particular combinations, each feature or element can be used alone without the other features and elements of the preferred embodiments or in various combinations with or without other features and elements of the present invention.

While the present invention has been described in terms of the preferred embodiment, other variations which are within the scope of the invention as outlined in the claims below will be apparent to those skilled in the art.

What is claimed is:

1. In a mesh network including a plurality of mesh points (MPs), a central database (DB) and a central controller (CC), a method comprising:
(a) at least one of the MPs broadcasting quality of service (QoS) information over a wireless medium;
(b) at least one of the MPs requesting QoS information directly from at least one other one of the MPs;
(c) at least one of the MPs storing QoS information in the central DB; and
(d) at least one of the MPs querying the central DB for QoS information associated with any of the MPs.

2. The method of claim 1 wherein step (a) further comprises broadcasting the QoS information using management frames.

3. The method of claim 1 wherein step (a) further comprises broadcasting the QoS information using control frames.

4. The method of claim 1 wherein step (a) further comprises broadcasting the QoS information using higher layer messages transported as payload of data frames.

5. The method of claim 1 further comprising:
(e) the MPs reporting QoS information to the CC; and
(f) the CC sending the reported QoS information to all of the MPs.

6. The method of claim 1 further comprising:
(e) the MPs reporting QoS information to the CC; and
(f) the CC sending a portion of the reported QoS information relative to a subset of the MPs.

7. In a mesh network including a plurality of mesh points (MPs), a method comprising:
(a) a first one of the MPs receiving quality of service (QoS) information from at least one other one of the MPs; and
(b) the first MP updating its own QoS information based on the received QoS information.

8. The method of claim 7 wherein the QoS information includes configuration parameters used by first MP.

9. The method of claim 7 wherein the QoS information includes enhanced distributed channel access (EDCA) parameter sets.

10. The method of claim 7 wherein the mesh network further comprises a plurality of mesh access points (MAPs) connected to mesh backhaul and client access interfaces, the method further comprising:
(c) coherently coordinating QoS policies between the backhaul and client access interfaces; and
(d) prioritizing access category (AC) for the mesh backhaul and client access interfaces.

11. A mesh network comprising:
(a) a plurality of mesh points (MPs);
(b) a central database (DB); and
(c) a central controller (CC), wherein at least one of the MPs broadcast quality of service (QoS) information over a wireless medium, at least one of the MPs request QoS information directly from at least one other one of the MPs, at least one of the MPs store QoS information in the central DB, and at least one of the MPs query the central DB for QoS information associated with any of the MPs.

12. The mesh network of claim 11 wherein the QoS information is broadcasted using management frames.

13. The mesh network of claim 11 wherein the QoS information is broadcasted using control frames.

14. The mesh network of claim 11 wherein the QoS information is broadcasted using higher layer messages transported as payload of data frames.

15. The mesh network of claim 11 wherein each MP comprises:
a transmitter for reporting QoS information to the CC; and
a receiver for receiving reported QoS information from the CC.

16. The mesh network of claim 11 wherein the CC comprises a transmitter for broadcasting a portion of QoS information received from one or more of the MPs to a subset of the MPs.

17. A mesh network comprising:
(a) a plurality of mesh points (MPs); and
(b) a plurality of mesh networks, wherein at least one of the MPs receives quality of service (QoS) information from the plurality of mesh networks, and the at least one MP updates its own QoS information based on the received QoS information.

18. The mesh network of claim 17 wherein the QoS information includes configuration parameters used by the at least one MP.

19. The mesh network of claim 17 wherein the QoS information includes enhanced distributed channel access (EDCA) parameter sets.

20. The mesh network of claim 17 wherein the mesh network further comprises a plurality of mesh access points (MAPs) connected to mesh backhaul and client access interfaces, the MAPs comprising:
means for coherently coordinating QoS policies between the backhaul and client access interfaces; and
means for prioritizing access category (AC) for the mesh backhaul and client access interfaces.

21. A method of differentiating packets in a mesh network, the method comprising:
(a) receiving a packet;
(b) determining the type of packet;
(c) mapping the packet to a selected one of a plurality of sets of channel access parameters based on the type of packet; and
(d) transmitting the packet in accordance with parameters associated with the selected set of channel access parameters.

22. The method of claim 21 wherein the channel access parameters are access categories (ACs).

23. The method of claim 21 wherein the sets of parameters are mesh backhaul specific and are stored in a table of a mesh point.

24. The method of claim 21 wherein the parameters specify an inter-frame space (IFS) time for accessing a medium.

25. The method of claim 21 wherein the parameters specify minimum and maximum contention windows.

26. The method of claim 21 wherein the parameters specify transmission opportunity (TXOP) limits.

27. The method of claim 21 wherein the parameters are quality of service (QoS) parameters.

28. The method of claim 27 wherein each QoS parameter defines an enhanced distributed channel access (EDCA) QoS policy.

29. The method of claim 27 wherein each channel access parameter is associated with a particular priority level.

30. A wireless communication system for transmitting packets, the system comprising:
a mesh network including at least one mesh point (MP); and
a mesh access point (MAP) for controlling packet transmissions inside and outside of the mesh network, wherein each packet is mapped to a selected one of a plurality of sets of channel access parameters based on the type of packet, and the packet is transmitted in accordance with parameters associated with the selected set of channel access parameters.

31. The system of claim 30 wherein the channel access parameters are access categories (ACs).

32. The system of claim 30 wherein the sets of parameters are mesh backhaul specific and are stored in a table of a mesh point.

33. The system of claim 30 wherein the parameters specify minimum and maximum contention windows.

34. The system of claim 30 wherein the parameters specify an inter-frame space (IFS) time for accessing a medium.

35. The system of claim 30 wherein the parameters specify transmission opportunity (TXOP) limits.

36. The system of claim 30 wherein the parameters are quality of service (QoS) parameters.

37. The system of claim 36 wherein each QoS parameter defines an enhanced distributed channel access (EDCA) QoS policy.

38. The system of claim 36 wherein each channel access parameter is associated with a particular priority level.

39. In a mesh network including a plurality of mesh points (MPs) and a central database (DB), a method comprising:
(a) a first one of the MPs receiving quality of service (QoS) information from at least one of another one of the MPs and the central DB; and
(b) the first MP updating its own QoS information based on the received QoS information.

40. The method of claim 39 wherein the QoS information includes configuration parameters used by first MP.

41. The method of claim 39 wherein the QoS information includes enhanced distributed channel access (EDCA) parameter sets.

42. In a mesh network including a plurality of mesh points (MPs) and a central controller (CC), a method comprising:
(a) a first one of the MPs receiving quality of service (QoS) information from at least one of another one of the MPs and the CC; and
(b) the first MP updating its own QoS information based on the received QoS information.

43. The method of claim 42 wherein the QoS information includes configuration parameters used by first MP.

44. The method of claim 42 wherein the QoS information includes enhanced distributed channel access (EDCA) parameter sets.
